(19) United States
(12) Patent Application Publication
(10) Pub. No.: US 2023/0321684 A1
(43) Pub. Date: Oct. 12, 2023

(54) Apparatus for Electrically Powered Liquid Feature

(71) Applicant: UNI-POWA CORPORATION LTD., Weston-super-Mare (GB)

(72) Inventors: Simon Reeves-Jackson, Weston-super-Mare (GB); Paul Dack, Ripley (GB); Autumn Danks, Weston-super-Mare (GB)

(21) Appl. No.: 18/210,015

(22) Filed: Jun. 14, 2023

Related U.S. Application Data
(63) Continuation-in-part of application No. PCT/GB2021/053265, filed on Dec. 13, 2021.
Application No. PCT/GB2021/053265 is a continuation-in-part of application No. 17/123,072, filed on Dec. 15, 2020.
Application No. PCT/GB2021/053265 is a continuation-in-part of application No. 17/123,072, filed on Dec. 15, 2020.
Application No. 17/123,072 is a continuation-in-part of application No. PCT/GB2019/051698, filed on Jun. 18, 2019.

(30) Foreign Application Priority Data
Jun. 18, 2018 (GB) 1809958.0
Mar. 29, 2019 (GB) 1904476.7
Sep. 30, 2021 (GB) 2114061.1

(51) Int. Cl. B05B 17/08; B05B 9/043; F04B 23/02

(52) U.S. Cl. CPC B05B 17/08; F04B 23/023; B05B 9/043

(57) ABSTRACT

An apparatus for an electrically powered liquid feature comprises a unit including a liquid pump and a rechargeable power source arranged to provide power to the pump for operation of the liquid feature. The unit may be removably installed in a reservoir having a cover that supports decorative features, such as pebbles, gravel and/or plants. The cover may have partitions so as to provide a pattern of different decorative features. One or more translucent or transparent features may be removably attached to the upper side of the cover. The cover may allow light to pass through from the unit to these features. There may be provided an outlet portion removably connected above the cover. The outlet portion may comprise a tiered cascade feature. Alternatively, the outlet portion may comprise a plurality of interconnected, stacked components. Alternatively, the outlet portion may comprise an adapter to which a statue or figurine may be removably attached.

### RELATED APPLICATIONS

The present application is a continuation-in-part of International Application No. PCT/GB2021/053265 filed on Dec. 13, 2021, which claims benefit of priority to United Kingdom Patent Application No. GB2114061.1 filed on Sep. 30, 2021 and to U.S. patent application Ser. No. 17/123,072 filed on Dec. 15, 2020. The present application is also a continuation-in-part of U.S. patent application Ser. No. 17/123,072 filed on Dec. 15, 2020, which is a continuation-in-part of International Application No. PCT/GB2019/051698 filed on Jun. 18, 2019, which claims the benefit of United Kingdom Patent Application No. GB1809958.0 filed on Jun. 18, 2018, and of United Kingdom Patent Application No. GB1904476.7 filed on Mar. 29, 2019. The disclosures of the aforementioned applications are all expressly incorporated herein by reference in their entireties.

### FIELD OF THE INVENTION

The present invention relates to apparatus for an electrically powered water (or other liquid) feature.

### BACKGROUND OF THE INVENTION

Conventional electrically powered water features, particularly for indoor or garden use, generally fall into two categories: mains-powered, or solar-powered. Mains-powered water features suffer from the inconvenience of requiring a mains cable connection, with associated safety issues. Solar-powered water features may be completely self-contained but require strong sunlight to operate effectively; this renders them unsuitable for use indoors, or in countries where strong sunlight is not often available.

Conventional water features may include decorative and/or structural components, made for example from stone or resin. These components may be expensive to manufacture and bulky to transport. Moreover, they are not easily reconfigurable to provide the decorative and/or structural effects desired by customers.

WO-A-2019/243800, filed by the present applicant, discloses a unit for a water (or other liquid) feature, including a pump, a rechargeable battery and control electronics within a housing comprising upper and lower housing parts. The battery is connectable to a power source for recharging, either wirelessly or through waterproof contacts.

### STATEMENTS OF THE INVENTION

Aspects of the present invention are defined by the accompanying claims.

Embodiments of the invention comprise apparatus for an electrically powered liquid feature, including a unit including a housing containing a pump and a rechargeable power source for the pump. The unit may include a contactless or contact power receiver for charging the power source. The power receiver may be positioned in the housing, for example in an upper portion of the housing. The unit may include one or more light sources.

The unit may be controlled by a user-actuable button, switch or other user-actuable means positioned on the unit. Settings of the unit may be controlled by a predetermined number or pattern of actuations of the user actuable means. The settings may be confirmed to the user by the light sources, for example by flashing a predetermined number of times to confirm the setting.

The unit may be removably installed in a reservoir. There may be provided apparatus for enabling this removable installation. The apparatus may be arranged for converting a receptacle, such as a pot or planter, to a water feature. Alternatively, the receptacle may be arranged to removably support the reservoir. The apparatus may include a lid or cover for the reservoir that supports decorative features, such as pebbles, gravel and/or plants. The cover may be partitioned so as to provide a pattern of different decorative features. Alternatively, the lid or cover may itself comprise one or more decorative features.

One or more translucent or transparent features may be removably attached to the upper side of the cover. The cover may allow light to pass from the light source(s) of the unit to these features. Alternatively or additionally the cover, or an additional unit provided on the cover, may itself include one or more light sources, arranged to illuminate these features.

There may be provided an outlet portion removably connected above the cover. The outlet portion may comprise a tiered cascade feature. Alternatively, the outlet portion may comprise a plurality of interconnected, stacked components. Alternatively, the outlet portion may comprise an adapter to which a statue or figurine may be removably attached.

Other aspects and optional features of the invention are defined in the dependent claims.

### BRIEF DESCRIPTION OF THE DRAWINGS

There now follows, by way of example only, a detailed description of preferred embodiments of the present invention, with reference to the Figures identified below.

FIGS. 1a to 1c show a first embodiment of mounting apparatus for mounting a unit in a receptacle, in which:

FIG. 1a is a perspective view of the mounting apparatus;

FIG. 1b is a side view of the mounting apparatus, with the unit and receptacle shown in dotted outline; and

FIG. 1c is an exploded perspective view from below of the mounting apparatus, with a close-up view of one of the hooks and ties thereof.

FIGS. 1d and 1e show a variant of the first embodiment of mounting apparatus for mounting a unit in a receptacle, in which:

FIG. 1d is an exploded view; and

FIG. 1e is a cross-sectional view.

FIGS. 2a to 2d show a second embodiment of mounting apparatus for mounting a unit in a receptacle, in which:

FIG. 2a is an exploded perspective view of the mounting apparatus, part of which is shown in cross-section;

FIG. 2b is an elevation of the mounting apparatus, part of which is shown in cross-section;

FIG. 2c is a perspective view of a tier portion of the apparatus; and

FIG. 2d is a perspective view of a tube portion of the apparatus.

FIG. 3 is an exploded view of a third embodiment of mounting apparatus for mounting the unit in a receptacle.

FIG. 4 is an exploded view of a variant of the third embodiment, including a filter.

FIGS. 5a-5b show partitions for use with the third embodiment, in which:

FIG. 5a shows the partitions located on the cover; and

FIG. 5b shows alternative forms of segments for insertion in the partitions.

FIG. 6 shows a handle for use with the third embodiment.

FIGS. 7a and 7b show a variant of the handle for use with the third embodiment.

FIGS. 8a-8c show elements for use with the third embodiment.

FIGS. 9a and 9b show exploded and assembled views of an illumination component for location on the cover.

FIG. 10a shows a mosaic insert for use with the third embodiment, and FIG. 10b shows the mosaic insert installed on the cover.

FIGS. 11a-11e show an adapter for use with the third embodiment, in which:

FIG. 11a is a side view of an adapter collar;

FIG. 11b is an exploded side view of parts of an adapter inner;

FIG. 11c is a perspective view showing the adapter inner being inserted into the adapter collar;

FIG. 11d is a perspective view showing the adapter in exploded view, being fitted onto the unit; and

FIG. 11e is a cross-section showing part of the adapter used in an arrangement with an alternative reservoir.

FIGS. 12a and 12b show outlet components for use with the unit in any of the embodiments, in which:

FIG. 12a is a cross-section of a component; and

FIG. 12b shows a plurality of said components of different shapes stacked together.

FIGS. 13a and 13b show an alternative outlet component, and the component installed in the third embodiment.

FIGS. 14a-14c show a support for supporting the reservoir, in which:

FIG. 14a is a perspective view of the support;

FIG. 14b is a perspective view of the support including a cradle; and

FIG. 14c is a perspective view of the support in a folded configuration.

FIG. 15 is a diagram of a system incorporating the unit.

FIG. 16 is a diagram showing the operation of a unit in an embodiment.

### DETAILED DESCRIPTION OF THE EMBODIMENTS

Pump and Power Source Unit

Embodiments of the invention comprise a pump 2 for pumping water (or other liquid) as part of the function of the water feature, for example for pumping water through a nozzle 3 in a fountain, or pumping water to a higher level in a cascade. The pump 2 is electrically powered, and includes a motor, a liquid inlet and a liquid outlet.

Power for the pump 2 is provided by a rechargeable power source 1, such as a one or more cells, batteries or capacitors. The capacity of the rechargeable power source 1 is sufficient to power the pump 2 for a length of time appropriate for the water feature, without requiring additional power from another source, such as a mains or solar power supply. Preferably, the rechargeable power source 1 is the sole power source for the pump 2.

Preferably, the pump 2 and rechargeable power source 1 are combined in a common housing, comprising an upper portion 21 and a lower portion 22 that are removably attachable together so as to provide a single, compact module or unit 20 that may be supplied as a self-contained water feature or as a component for integration into a water feature. The size and/or shape of the module or unit may be chosen to suit the application. In a specific example, the dimensions of the module or unit are 120×83 mm. The unit is preferably light and easily portable, weighing for example between 0.1 and 1 Kg, and preferably between 200 and 500 g.

The module or unit 20 may be submersible in water or other liquid, for example in a reservoir such as a pond, fountain reservoir or birdbath, to provide a water feature such as a fountain, cascade, or bubbler. In some embodiments, the unit could be designed for other types of water or liquid feature, such as for example a rain effect feature using oil rather than water.

The power source 1 may be rechargeable by contactless or wireless charging, for example by inductive charging in proximity to a contactless or wireless power transmitter 5 connected to a source of mains power, as described in the first and second embodiments of WO-A-2019/243800.

Alternatively, the power source 1 may be rechargeable by a contact connection, or a combination or selection of contact and wireless connections.

The unit 20 may include further features as disclosed in WO-A-2019/243800, the contents of which are incorporated herein by reference.

Specific embodiments of the invention are described in detail below. Similar features between different embodiments are described using the same reference numerals. In this description ‘upper’, ‘lower’, ‘top’, bottom’, ‘vertical’ and similar terms are defined with reference to the normal orientation of the module or unit when the pump 2 is in use, for example with the nozzle 3 projecting upwards.

Water Feature Installation

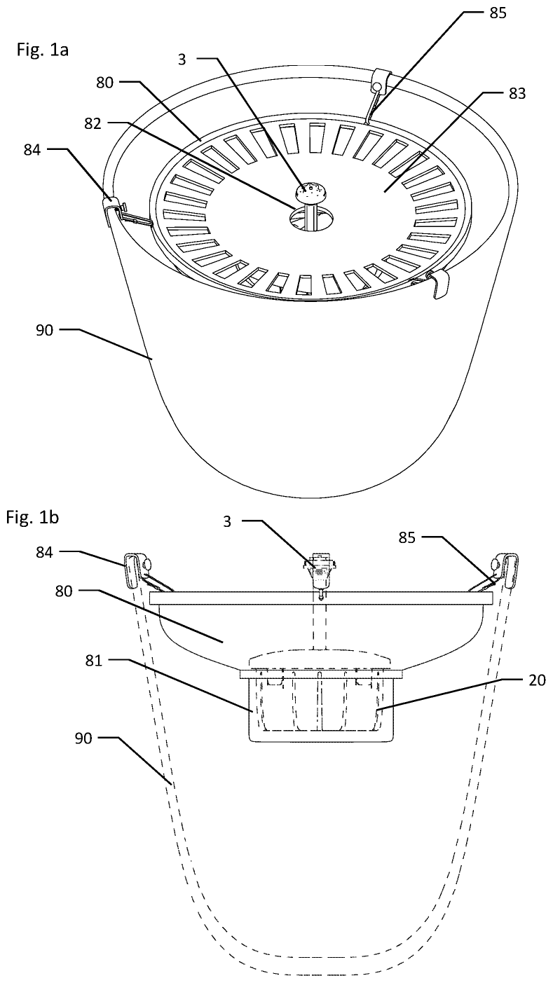

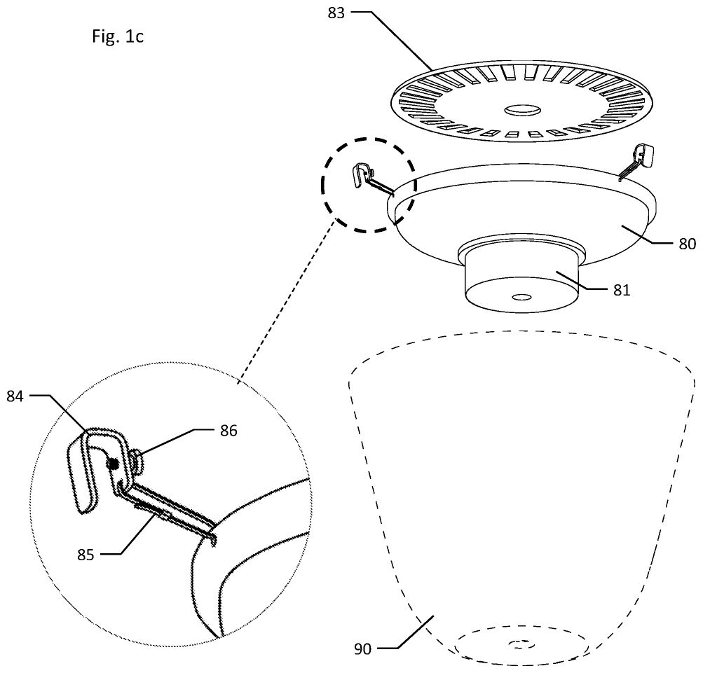

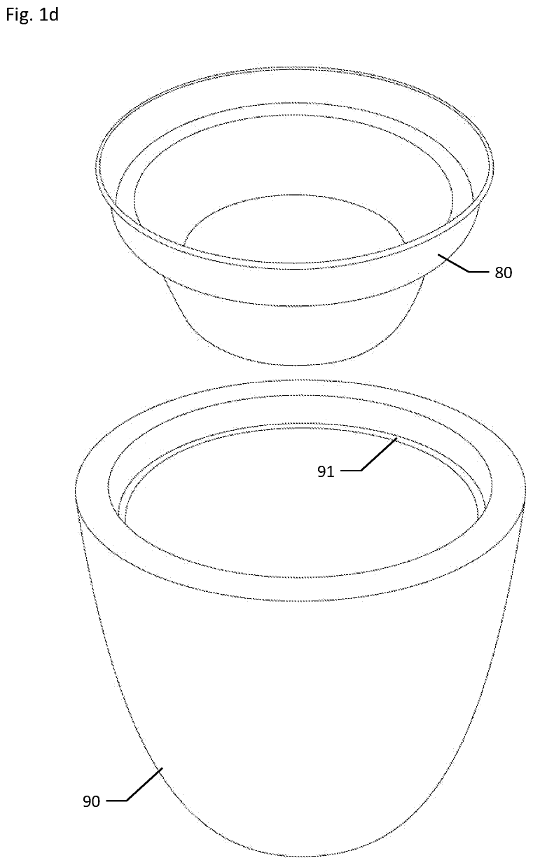

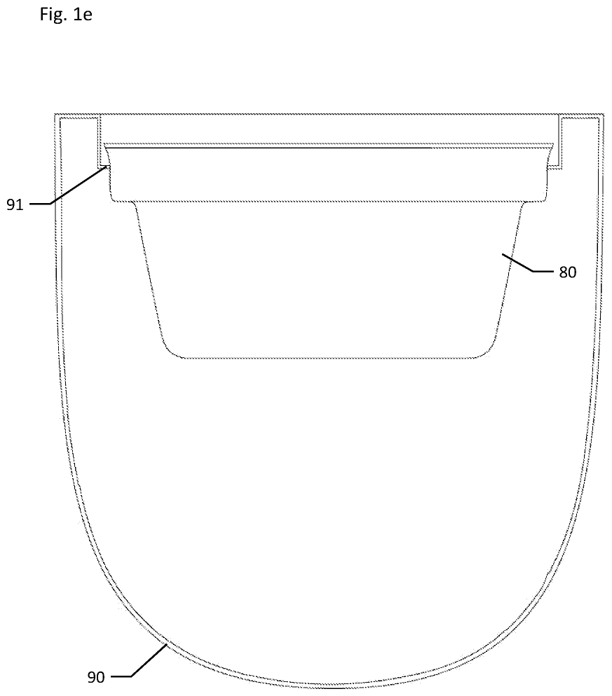

As shown in FIGS. 1a to 1c, a first embodiment of mounting apparatus for mounting the unit 20 comprises a bowl or reservoir 80 having a recess 81 at the bottom thereof for receiving the unit 20. The reservoir 80 and recess 81 comprise a liquid reservoir for holding the liquid to be pumped by the unit 20 and recovering the liquid emitted from the nozzle 3. The reservoir 80 is covered by a cover 83 which may support decorative items such as pebbles, gravel, plants, figurines etc., for example as described further below. Alternatively, the cover 83 may itself include decorative features. The cover 83 includes a central aperture 82 through which the nozzle extends. The cover 83 is perforated, for example by a plurality of further apertures 83a, 83b, to allow the liquid emitted from the nozzle 3 to drain back into the reservoir 80.

The reservoir 80 may be supported within an outer receptacle, such as a planter or pot 90 by a plurality of connectors, such as hangers or hooks 84 which fit over the rim of the pot 90 and are attached to the periphery of the reservoir 80 by corresponding loops or ties 85, which are adjustable in length to allow mounting in pots 90 of a range of different diameters. The ties 85 may be cable ties, turnbuckles or other adjustable length connectors. Each of the hooks 84 includes an adjustable screw 86 for clamping onto the rim of the pot 90; this allows use with pots 90 with rims of different thicknesses. This arrangement allows the unit 20 to be mounted on the rim of the pot 90, and is adjustable for different diameters and thicknesses of pot 90.

Instead of the hangers or hooks 84, the reservoir 80 may be supported by material such as soil or gravel, or may float on water or other liquid, within the pot 90. Alternatively, the reservoir 80 may have a rim that fits over the rim of the pot 90 and thereby supports the reservoir 80. In another alternative as shown in FIGS. 1d and 1e, the pot 90 includes an internal flange 91 or one or more inward projection(s) on which the outer rim of the reservoir 80 rests. The flange 91 may be formed as an integral part of the pot 90, for example by molding the pot 90 from plastics material. Alternatively, the pot 90 may be formed from ceramic material. In this alternative, the reservoir 80 is removably supported by the pot 90 without the need for separate supports.

In the above first embodiment, the pot 90 does not act as a reservoir for the liquid, but supports and provides a decorative surround for the reservoir 80. Alternatively, the reservoir 80 may include one or more apertures to allow liquid communication with the interior of the pot 90.

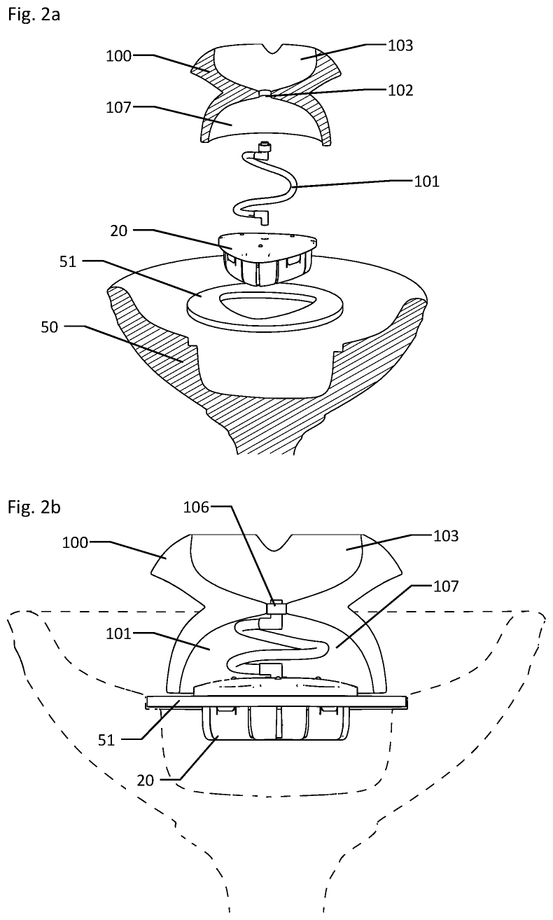

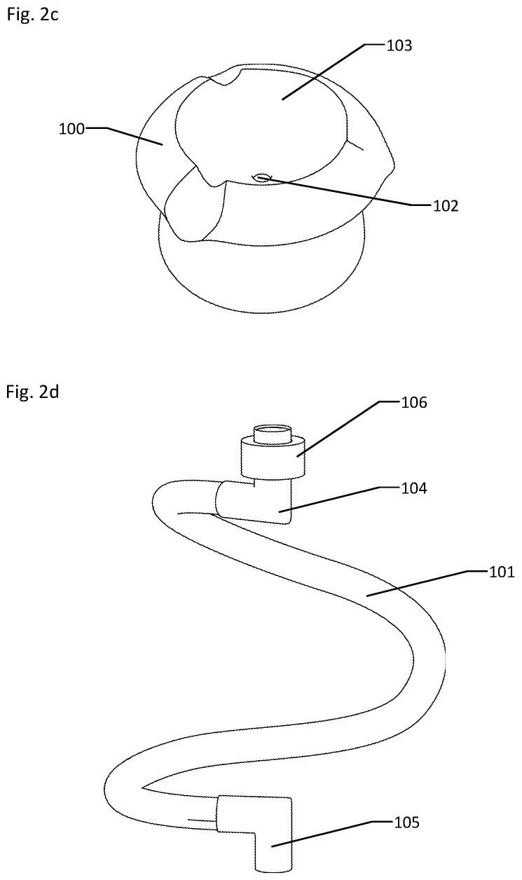

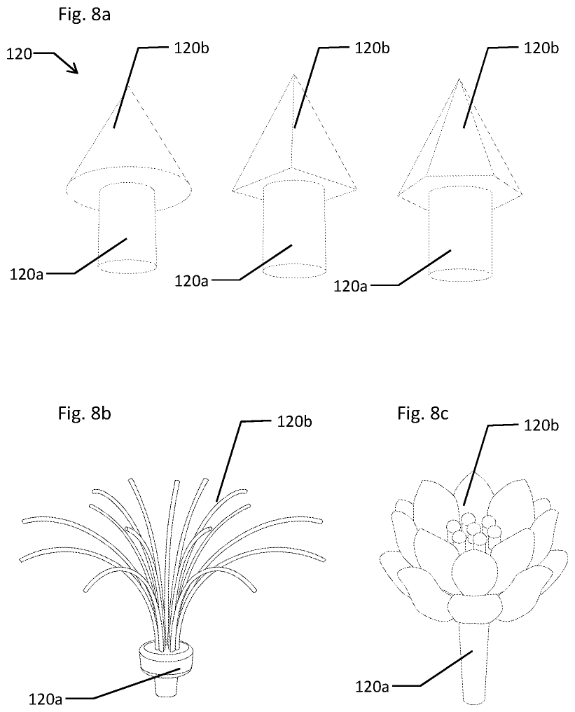

In a second embodiment as shown in FIGS. 2a to 2d, mounting apparatus for the unit 20 is similar to that of FIGS. 8A to 8C in WO-A-2019/243800, but includes a tier portion 100 positioned above the unit 20 (for example, resting on the adapter 51 or on the reservoir 50) and a tube 101 removably connectable at one end to the outlet aperture 30 of the unit 20 and at the other end to an aperture 102 leading to a bowl-shaped upper tier 103 of the tier portion 100. This arrangement provides a cascade effect, with liquid being pumped through the tube 101 to the upper tier 103, from which the liquid cascades into the reservoir 50 and thence is pumped through the unit 20.

As shown in FIG. 2d, the ends of the tube 101 comprise upper and lower right-angled elbow joints 104, 105, so that the tube 101 can fit compactly within a chamber 107 in a lower part of the tier portion 100. A seal 106 is provided around the upper end of the tube 101 so as to seal against the aperture 102.

The arrangement provides a cascade effect using components that can be removably installed above the unit 20, allowing the unit 20 to be removed for charging.

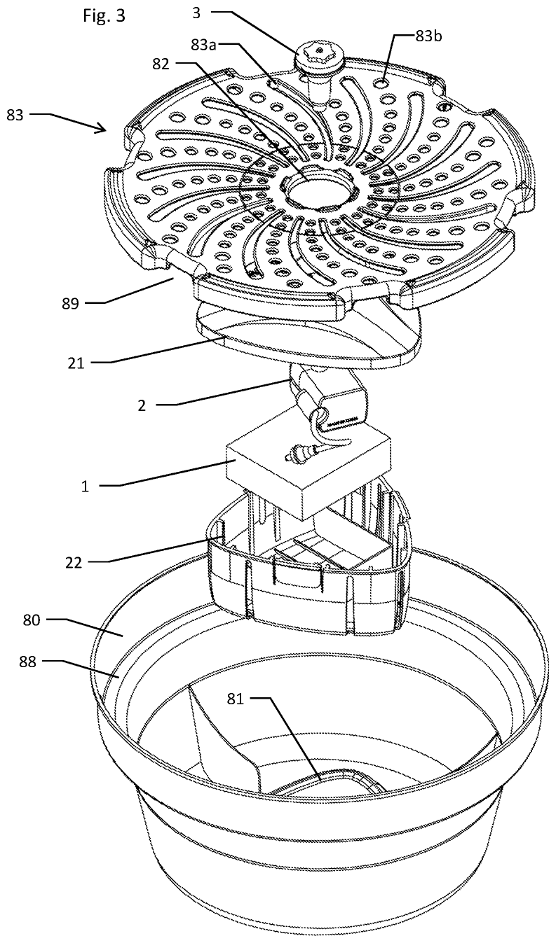

In a third embodiment as shown in FIG. 3, the cover 83 rests on an inner rim 88 around the recess 81 of the reservoir 80. Finger holes or recesses 89 are provided in the rim of the cover 83 to facilitate removal of the cover 83 from the reservoir 80. In this embodiment, the cover 83 has apertures or perforations comprising a plurality of radially extending slits 83a interspersed with smaller apertures 83b, such as approximately round holes. This arrangement provides a coarse filter to prevent gravel and stones from passing through the cover 83.

The reservoir 80 in this embodiment has an outer rim designed to fit the rim of a pot 90 so that the reservoir 80 is supported by the pot 90.

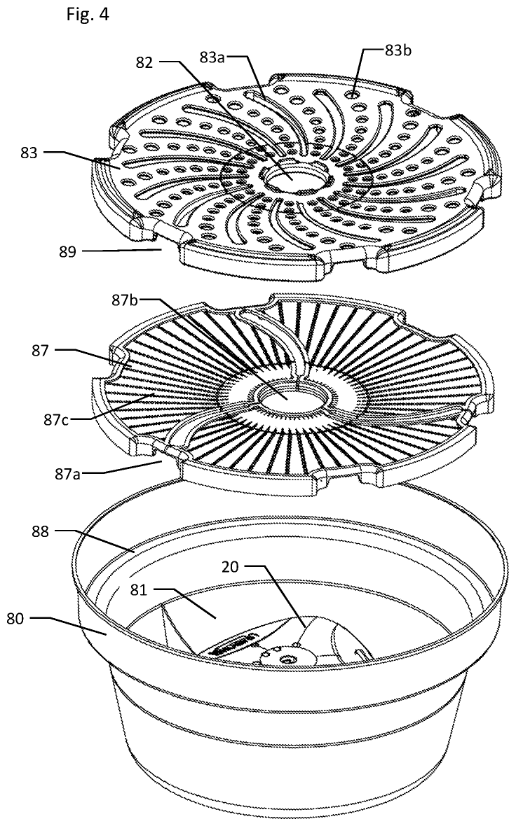

In a variant shown in FIG. 4, a filter 87 may be provided in or under the cover 83, to prevent silt and/or debris from falling into the interior of the reservoir 80 and entering the unit 20. The filter 87 may comprise an insert that is removably fitted into the underside of the cover 83, for example as a push fit. Holes or recesses 87a may be provided around the edge of the filter 87, corresponding to the finger holes or recesses 89 are provided in the rim of the cover 83.

The filter 87 has a central aperture 87b which aligns with the central aperture 82 of the cover 83, to allow the nozzle 3 to pass through. The filter 87 may have filter portions 87c, for example of nylon mesh or wire mesh.

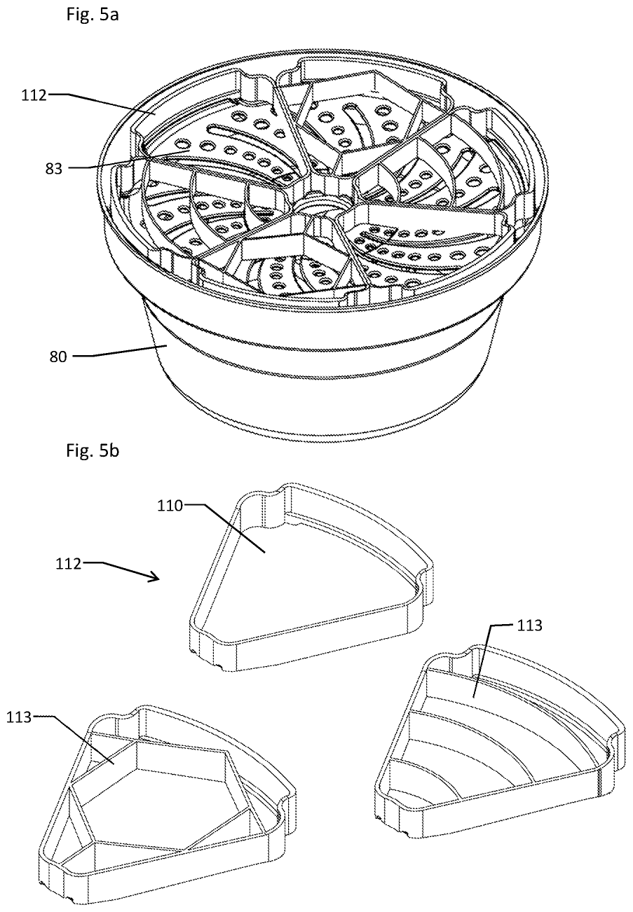

As shown in FIGS. 5a-5c, a plurality of partitions 112 may be placed on top of the cover 83 in order to define discrete areas for retaining different materials, such as pebbles, gravel or other decorative objects. The partitions 112 may comprise segments that fit together as shown in FIG. 5a to form partitions extending substantially over the cover 83, and may be held in place by an upper portion of the rim of the reservoir 80. The partitions 112 may have open or perforated bases 110 to allow water or other liquid to pass through.

The partitions 112 may have one or more internal partitions 113 used to hold material of different types in position within the partition 112. This allows a variety of different decorative effects to be achieved, comprising for example pebbles, gravel or other decorative objects of different colors, shapes and/or sizes to be arranged on the cover 83, on which a fountain effect is created by the unit 20 and the nozzle 3.

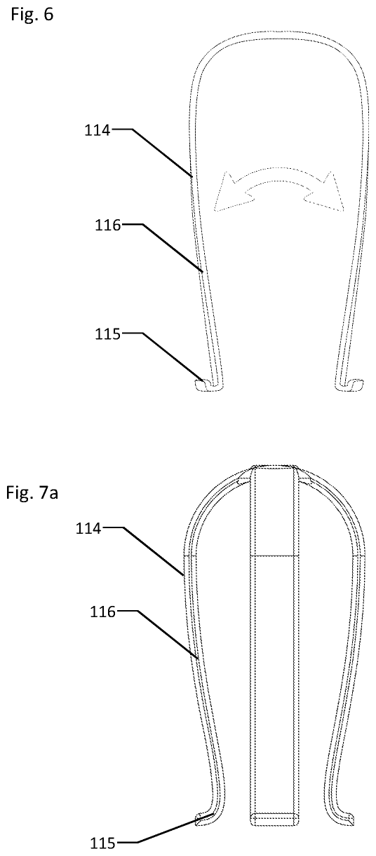

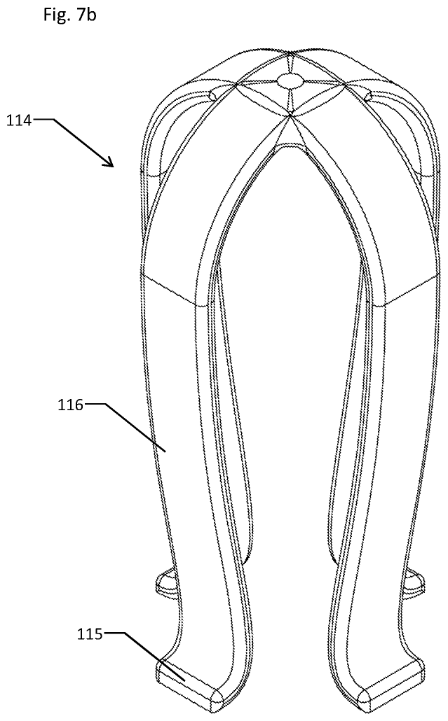

The cover 83 and attached features may be removed from the reservoir 80 by a detachable handle 114 as shown in FIG. 6, or a variant as shown in FIGS. 7a and 7b, comprising two or more resilient arms 116 joined at an upper end of the handle and having lower ends 115 that fit within the central aperture 82 of the cover 83. The lower ends 115 are biased radially outwardly by the resilient arms 116 so as to engage the periphery of the central aperture 82 and allow the cover 83 to be lifted by the handle 114. This conveniently allows the cover 83 to be lifted in a horizontal position so as to avoid disturbing any decorative arrangement on the cover 83 when accessing the unit 20 for recharging or servicing. The handle 114 may be lifted with one hand, whereas the finger holes or recesses 89 require two hands to lift the cover 83 horizontally.

FIGS. 8a to 8c show elements 120, such as pegs, having lower portions 120a which can be inserted in corresponding apertures in the cover 83, such as for example the holes 83b shown in the cover 83 of FIG. 3. The elements 120 may have a decorative upper portion 120b, such as the conical or pyramidal shapes shown in FIG. 8a, optical fibers as shown in FIG. 8b or a flower as shown in FIG. 8c. The lower portion 120a may be at least partially transparent or translucent so as to conduct light from under the cover 83, for example from the light source(s) 7 in the upper surface of the unit 20, to the upper portion 120b so that the element 120 appears illuminated above the cover 83. The upper portion 120b may be arranged to diffuse and/or conduct light and may include one or more color filters.

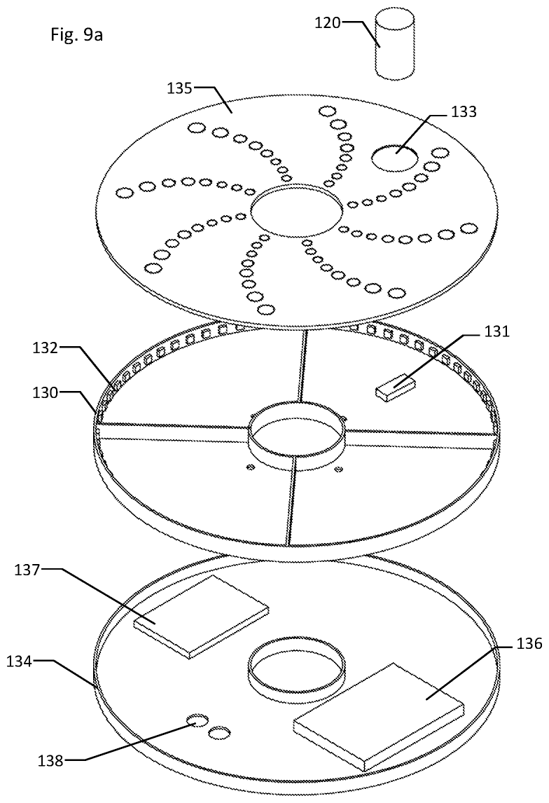

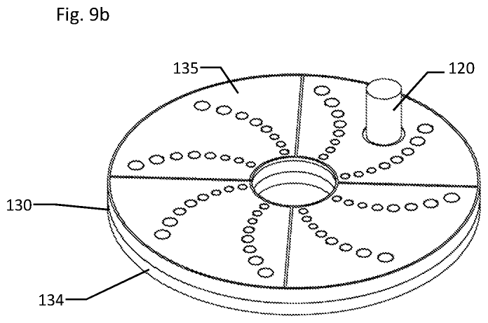

FIGS. 9a and 9b show a light emitting panel for location on or above the cover 83, and comprising an upper housing portion 130 having a translucent or transparent upper surface 135, and a lower housing portion 134. The upper housing 130 has a plurality of LEDs 132, such as ultraviolet (UV) LEDs, arranged around an inner rim thereof and arranged to diffuse light across the upper surface 135. The upper surface 135 may include one or more apertures or recesses 133 which may receive light transmitting elements such as the elements 120. Where the LEDs emit ultraviolet radiation, the elements may be fluorescent and/or phosphorescent, excited by UV radiation. The upper surface 135 may be configured to scatter light so as to give a decorative effect.

The LEDS 132 may be powered by one or more rechargeable batteries 136, housed in the lower housing portion 134, which may be recharged by a contact or contactless connection similar to that of the unit 20, via charging contacts which pass through contact holes 138 in the lower housing portion 134. A PCB 137 comprising control and driver electronics for the LEDs 132 is also housed in the lower housing portion 134.

When first powered on, the driver may switch on the LEDs 132 for a predetermined period of time (i.e. a starting illumination period) then may modulate the power delivered to the LEDs 132 to a lower level or switch them off completely, in order to conserve battery life. The LEDs 132 may be switched on periodically to maintain the glow of the phosphorescent elements in a ‘top up’ phase until the power is switched off.

The control electronics may be coupled to a sensor 131, provided within the upper housing portion 130, to detect the presence of the element 120 in the aperture or recess 133 and switch on or varying the power to the LEDs 132 in response thereto. The sensor 131 may be a magnetic switch, actuated by a magnet within the element 120.

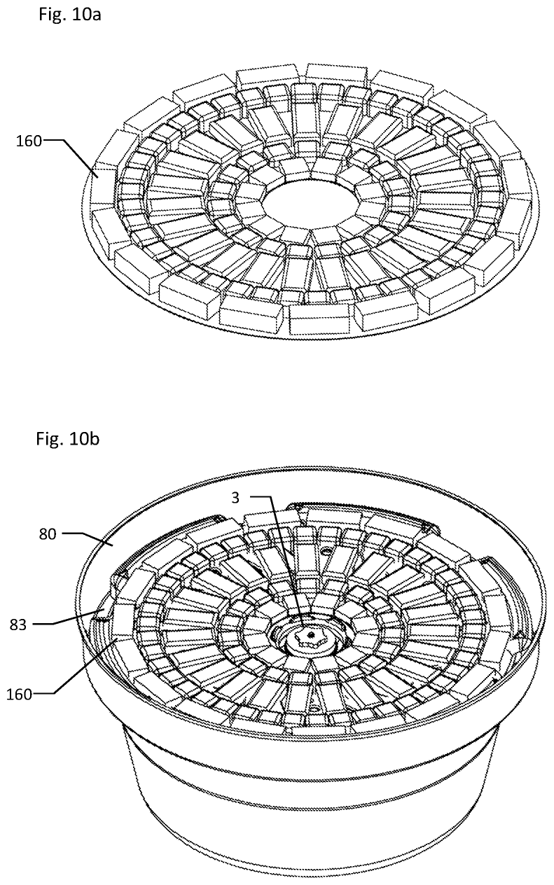

FIGS. 10a and 10b show a mosaic plate or insert 160, consisting for example of an array of transparent or translucent elements of different colors, connected together to form an integral part. The mosaic insert 160 may be located on or above the cover 83 so as to provide a decorative effect. Gaps between the transparent or translucent elements allow water or other liquid to drain through the mosaic insert 160. The mosaic insert 160 may be installed above the light emitting panel as described above.

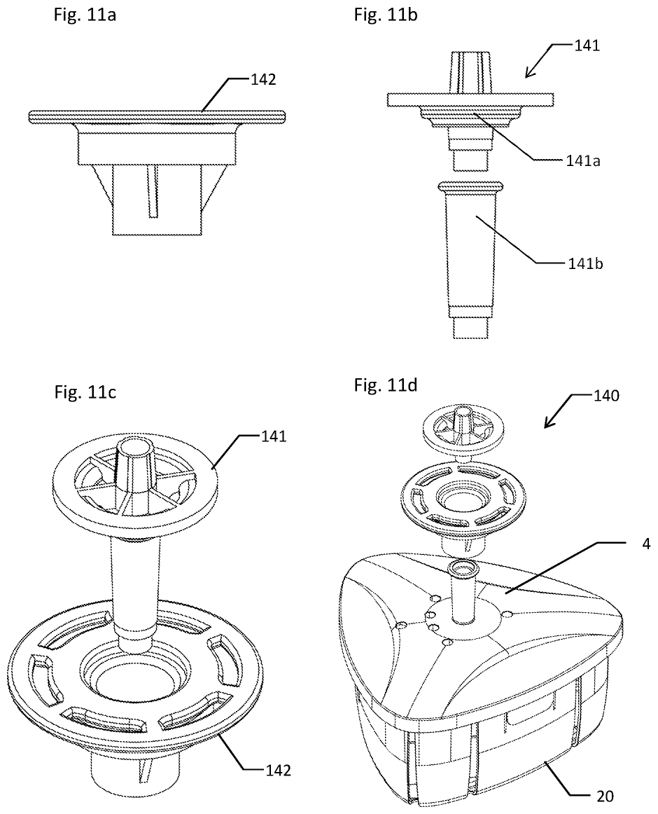

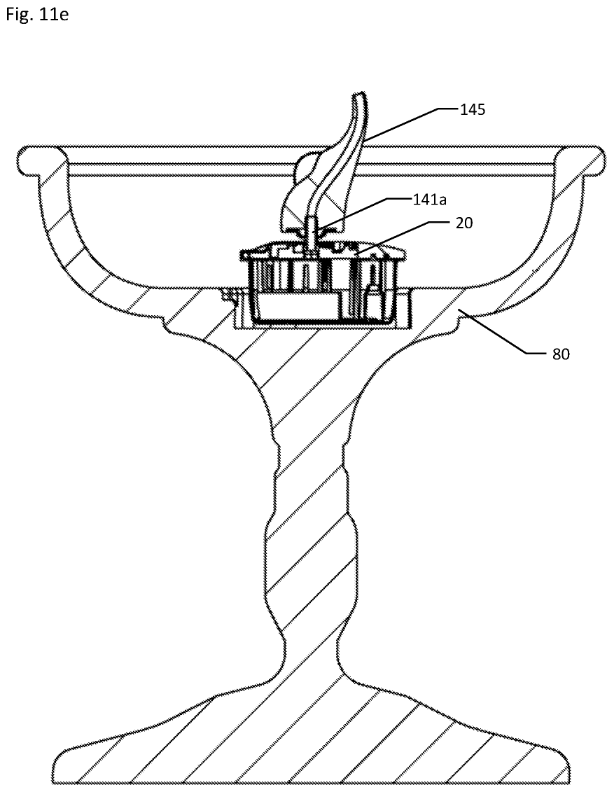

FIGS. 11a-11d show an adapter 140 connectable to the outlet of the unit 20 through the central aperture 82 of the cover 83, and optionally additional features located above the cover 83. The adapter 140 may support a statue or figurine 145 which serves as a liquid outlet e.g. containing a spout. The adapter comprises an inner adapter 141 that is removably attachable to the statue or figurine, the inner adapter 141 fitting within an adapter collar 142 having a rim with keyed finger grips which locate on ribs of the cover 83. A user may press down on the rim of the adapter collar 142 while removing the inner adapter 141 and/or statue or figurine. This allows the statue or figurine to be removed from/replaced on the cover 83 without disturbing material arranged on the upper surface of the cover 83.

The inner adapter 141 comprises an upper portion 141a removably connectable to a lower portion 141b or stem. The upper portion 141a may be connectable directly to the outlet of the unit 20, for installations that do not include the cover 83 as shown for example in FIG. 11e in which the unit 20 is located in an alternative reservoir 80 and a figurine 145 is connected to the outlet of the unit 20 using the upper portion 141a. This arrangement allows the same figurine 145 to be used in arrangements with or without the cover 83.

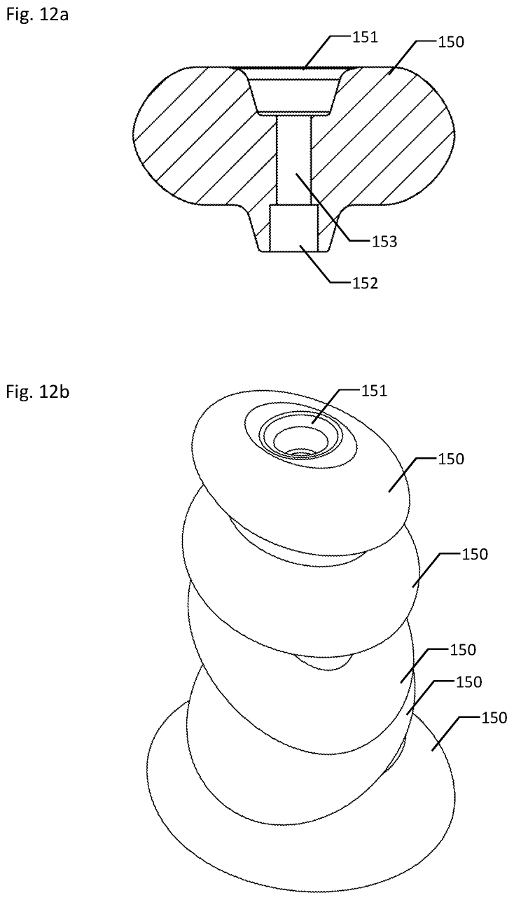

FIG. 12a shows a component 150 that may be connected directly or indirectly to the outlet of the unit, having a liquid inlet 152 and a liquid outlet 151 connected together by a liquid passage 153. A plurality of components 150 can be stacked one on top of the other, as shown in FIG. 12b, with the liquid inlet 152 of an upper one of the components 150 fitting the liquid outlet 151 of a lower one of the components 150, thus providing both liquid connection and structural stability. The components 150 may preferably be stacked in any order. The components 150 may have the appearance of pebbles of different sizes, thus providing a water or liquid feature having the appearance of a stack of pebbles. The lowermost one of the outlet components may be connected to the outlet of the unit 20, either directly or through the cover 83 via the adapter 140.

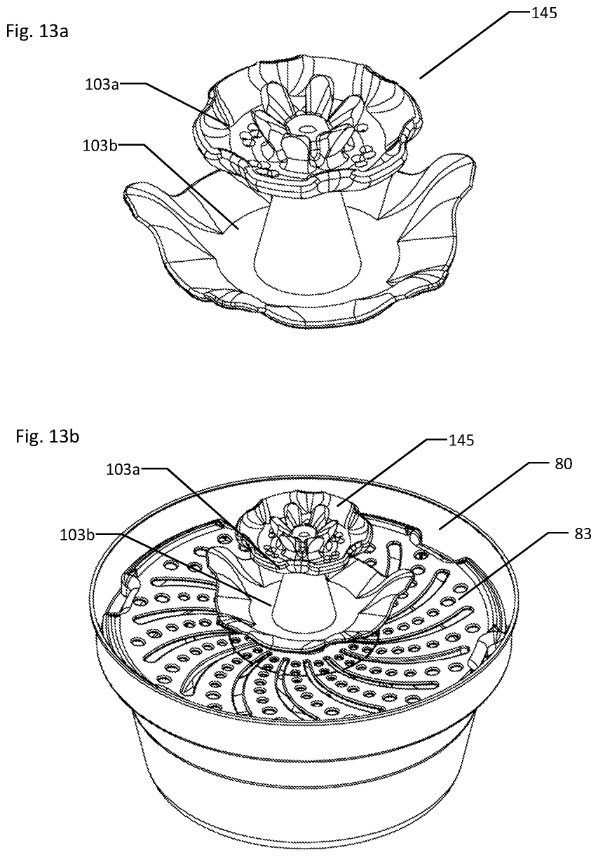

FIGS. 13a and 13b show an alternative statue or figurine 145 attached above the cover 83, and comprising an upper tier 103a in which liquid from an outlet 151 collects before cascading into a lower tier 103b, in which liquid collects before cascading through the cover 83 and back into the reservoir 80.

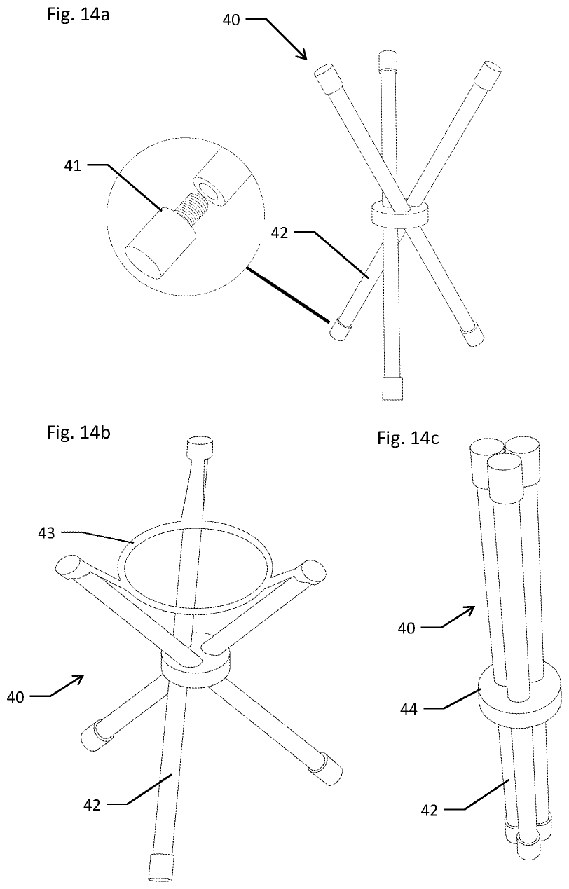

The reservoir 80 in at least some embodiments may be supported by a self-supporting stand 40, which may be adjustable. The stand 40 may for example be mounted within the pot or planter 90. In the example shown in FIGS. 14a-14c, the stand comprises a tripod 40 comprising three legs 42 with feet 41 (shown in close-up in FIG. 14a) that are adjustable in length, for example by a screw fitting into the ends of the tripod legs 42. As shown in FIG. 14b, there may be provided a cradle 43 that fits onto the upper ends of the tripod legs 42, with the unit 20 being supported within the cradle 43. The legs 42 may be pivotably mounted within a hub 44 to allow the tripod 40 to be folded, as shown in FIG. 14c.

System Components

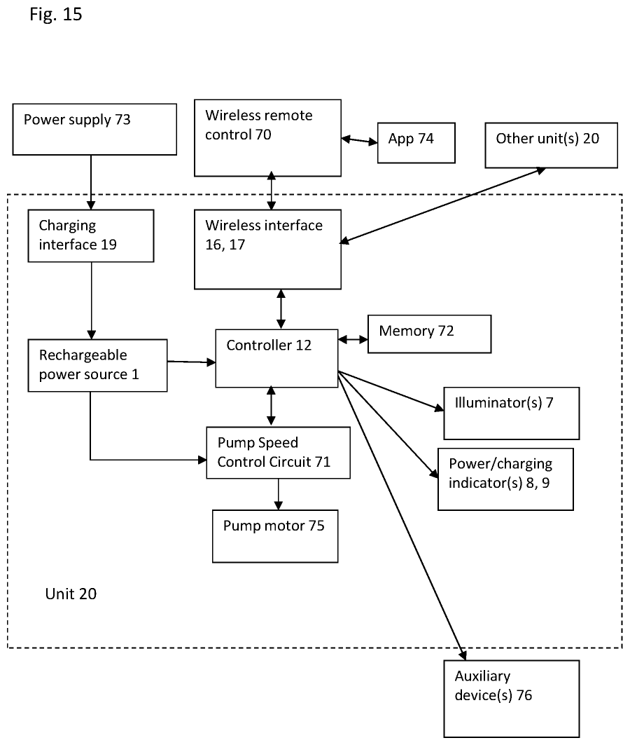

FIG. 15 shows schematically components of a system incorporating the unit 20. Within the unit 20 there is provided a charging interface 19, such as wireless power receiver 6, or contacts 60, for connection to a power supply 73. These provide power to the rechargeable power source(s) 1, for example by means of a charge control circuit. Power from the rechargeable power source(s) 1 is provided to a pump motor 75 of the pump 2, through a pump speed control circuit 71.

A controller 12, such as a microcontroller or microprocessor, controls the switching on and off as well as the speed of the pump motor 75 via a pump speed control circuit 71. Advantageously, the controller 12 may control the speed so as to increase the life of the rechargeable power supply 1. For example, the controller 12 may provide a pulsed operation setting, whereby the speed is varied periodically so as to provide a pulsed effect. This may reduce power consumption by up to 50%, without materially affecting the visual appearance of the water feature. Unit settings may be stored in a memory 72 accessed by the controller 12.

The controller 12 may communicate via a wireless interface, such as Bluetooth and/or Wi-Fi module 16 and/or IR receiver 17, to a wireless remote control 70 such as a mobile device running an app 74, or a dedicated remote control, so as to allow remote control of functions of the device.

To increase the range of wireless communication, an external antenna may be provided for the wireless interface. The external antenna may be molded into the upper portion 21 and/or the nozzle 3.

The controller 12 and/or the remote control 70 may be programmable so as to provide functions of the unit 20 at specific times, for specific durations, or in response to triggers such as proximity of a user.

The controller 12 may connect via a wireless interface, such as a Wi-Fi interface, to a network, for example for remote control or firmware updates over the network.

The controller 12 may also control the light source(s) 7, power indicator 8, charging indicator 9, and/or one or more auxiliary devices 76. The auxiliary device(s) 76 may be integrated within the unit 20 or may be external to the unit 20, and may comprise: one or more motors for driving additional functions such as decorative moving parts; one or more sounds generators for music or sound effects; and one or more ultrasonic misters.

In an alternative arrangement, the unit 20 may be controlled by a user interface provided on the unit 20 itself, rather than by a wireless remote control. For example, a multi-function button (MFB) may be provided on the unit 20, such as on the upper surface of the upper portion 21. This allows the system to be more cost-effective because there is no need for remote control 70 or the wireless interface 16, 17. Moreover, the system may be more power-efficient because there is no need to power the wireless interface 16, 17 in order to detect input from the remote control 70.

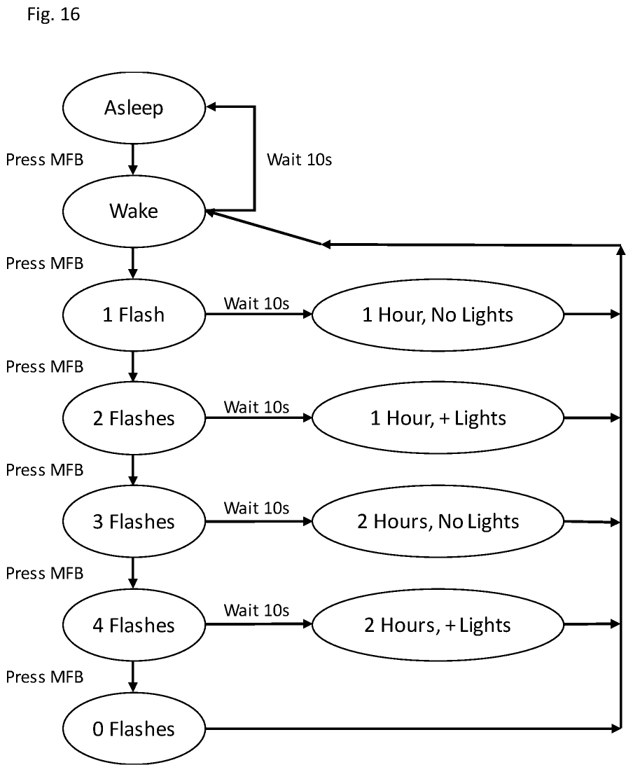

The operation of the unit 20 may be controlled by one or more presses of the MFB, as shown for example in FIG. 16 in which one or more of the light sources 7 flash the number of times indicated to confirm the pressing of the MFB. After an interval such as 10 seconds has elapsed since the last press of the MFB, the unit 20 may adopt a corresponding setting such as running the pump 2 for the number of hours shown, and either setting the light sources 7 on or off during that time.

### Alternative Embodiments

Features from one of the above embodiments may be combined with features of another one of the embodiments, where these are compatible.

The embodiments described above are illustrative of rather than limiting to the present invention. Alternative embodiments apparent on reading the above description may nevertheless fall within the scope of the invention.

What is claimed is:

1. An apparatus for an electrically powered liquid feature, comprising:
a unit including a housing containing a pump and a rechargeable power source arranged to provide power to the pump for operation of the liquid feature;
a reservoir for removably housing the unit such that liquid contained within the reservoir is supplied to the pump of the unit; and
a removable cover, arranged such that the unit may be located in the reservoir under the cover, and having at least one aperture allowing liquid pumped by the pump to pass therethrough, the cover also allowing liquid to drain therethrough back into the reservoir.

2. The apparatus of claim 1, wherein the cover includes a filter insert removably attached or attachable to an underside of the cover.

3. The apparatus claim 1, wherein the cover includes a plurality of radially extending slits and/or a plurality of apertures.

4. The apparatus of claim 1, wherein the unit includes one or more light sources and the cover allows light from the light sources to pass therethrough.

5. The apparatus of claim 4, including one or more light diffusing elements removably attachable to an upper side of the cover.

6. The apparatus of claim 1, including a light-emitting panel for location on or above the cover, wherein the light-emitting panel comprises one or more light sources.

7. The apparatus of claim 6, wherein the light-emitting panel has a transparent or translucent upper surface.

8. The apparatus of claim 6, including a rechargeable power supply for the light source or sources.

9. The apparatus of claim 6, including one or more light-transmitting elements removably attachable or attached to the light-emitting panel.

10. The apparatus of claim 9, including one or more sensors arrange to detect the light-transmitting element or elements, and a controller arranged to control the one or more light sources in response to detection of the light-transmitting element or elements.

11. The apparatus claim 1, including a plurality of partitions defining a plurality of recesses for retaining material on an upper surface of the cover.

12. The apparatus of claim 1, including a detachable handle for attachment to the cover so as to enable lifting of the cover.

13. The apparatus of claim 1, further comprising a mosaic insert for arrangement on or above the cover.

14. The apparatus of claim 1, further including an adapter for connecting a statue or figurine to an outlet of the pump, the adapter being arranged to pass through the aperture in the cover.

15. The apparatus of claim 14, wherein the adapter comprises an inner part removably attachable to the statue or figurine, and an outer part attachable to the cover.

16. The apparatus of claim 1, including a receptacle within which the reservoir is removably supported or supportable.

17. The apparatus of claim 16, wherein the reservoir includes an outer rim which is supported by a portion of the receptacle.

18. The apparatus of claim 17, wherein the outer rim of the reservoir is supported by one or more inward projections within the receptacle.

19. An apparatus for an electrically powered liquid feature, comprising: a unit including a housing containing a pump and a rechargeable power source arranged to provide power to the pump for operation of the liquid feature; a liquid reservoir arranged to removably receive the unit; and a liquid outlet positionable above the liquid reservoir and removably connectable to the pump, wherein the liquid outlet comprises a tier in which liquid collects before cascading from the tier back into the reservoir.

20. An apparatus for an electrically powered liquid feature, comprising: a unit including a housing containing a pump and a rechargeable power source arranged to provide power to the pump for operation of the liquid feature; a liquid reservoir arranged to removably receive the unit; and a liquid outlet positionable above the liquid reservoir and removably connectable to the pump, wherein the liquid outlet comprises a plurality of removably interconnected or interconnectable, stacked components.
